(19) United States
(12) Patent Application Publication
(10) Pub. No.: US 2018/0091652 A1
(43) Pub. Date: Mar. 29, 2018

(54) TRACKING ENGAGEMENT OF MULTITASKING USERS WITH AN ONLINE APPLICATION

(71) Applicant: salesforce.com, inc., San Francisco, CA (US)

(72) Inventors: Noman Juzar Lakdawala, Fremont, CA (US); Kendra Nicole Fumai, San Francisco, CA (US); Andrew LINTNER, Royal Oak, MI (US)

(73) Assignee: salesforce.com, inc., San Francisco, CA (US)

(21) Appl. No.: 15/280,958

(22) Filed: Sep. 29, 2016

(51) Int. Cl. H04M 3/51; H04M 3/36

(52) U.S. Cl. CPC H04M 3/5175; H04M 3/36; H04M 3/5191

(57) ABSTRACT

Systems and methods for tracking engagement with an online application while multi-task among assignments are disclosed. The technology tracks time an agent actively spends on each work item by tracking how long the tab is in-focus in the service console. Agents log in, and work may be routed to them, based on their capacity. After the agent accepts the work items, the system tracks the time the agent stays on each open work tab. Each time the agent switches to a different tab, or back and forth, the time count stops for the previous tab and starts counting for the current tab. When the agent closes the tab, the total active time spent on the related tab is saved along with the agent's work record. If an agent logs out, the active time is saved for all of their open work tabs and subtabs.

### FIELD OF DISCLOSURE

The technology disclosed describes systems and methods for tracking user engagement with an online application while the user is multi-tasking among assignments, in a multi-tenant environment. The methods disclosed include managing digital data for a plurality of tenants to software instances, each tenant of the plurality of tenants comprising a group of users who share a common access with a specific set of privileges to a software instance of at least one application.

### INTRODUCTION

Customer service is moving toward more personalized one-on-one communication with consumers, through the many channels and on the many devices they use. Many companies track the work time of agents at a high level, tracking time working and time spent away from the computer, and more detailed systems track how long the agent takes to close a given work item. When contact centers were driven by phone calls and agents tended to work on a single task at a time, this approach worked fine. As customers multi-task more, agents who respond to the customers tend to work on multiple work items generated from work cases, chats and social media conversations, as well as phone texts and messages, multiplexing as they respond.

Omni-channel is a multichannel approach for providing customers with a seamless experience, whether the customer is interacting online via email, web, short message service (SMS), chat, or live agent video support on a desktop or mobile device, by telephone, or in a brick and mortar store.

Service channels for contact centers are evolving significantly for organizations. In this era of Omni-channel, a business determines the relative priority for handling a variety of service channels, and routes issues accordingly. In order to select a preferred agent to receive any given piece of work, the system can evaluate the availability of the agents in the org, their queue membership, their current workload, and the priority of the work. The customer service solution can route any type of incoming work item to the most qualified, available agents. A single agent may receive multiple work items and be expected to multiplex between customers, handling work items presented on their console, using a blended agent approach.

Service agents are often able to multiplex—handling multiple requests for tasks that need to be completed. Each of the multiple work items that an agent may be working on simultaneously can be displayed in a separate tab, subtab or window in the agent's console. When multiplexing among multiple work tasks, it becomes important to be able to track the amount of time an agent actively spends on each of multiple requests displayed on their task-oriented tabs.

Tracking the length of time it takes an agent to close a work tab is no longer relevant to agent productivity. It is very challenging to know how productive agents are when they are working on many tasks at once.

An opportunity arises to improve the experience for customers and for workers using disclosed tracking of user engagement with an online application while the user is multi-tasking among assignments, including making it feasible for very large enterprise service operation centers to have improved operation insights for very large pools of agents.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates one example environment for tracking user engagement with an online application while the user is multi-tasking among assignments, in a multi-tenant environment.

FIG. 2 shows a block diagram of components for tracking user engagement with an online application while the user is multi-tasking among assignments.

FIG. 3 shows an omni-channel example user interface for setting agent status.

FIG. 4 illustrates an omni-channel example user interface for an agent to use to select work tasks to handle.

FIG. 5 shows an example user interface that displays multiple work tasks, each on a separate tab, for a single agent.

FIG. 6 shows an example omni-channel handle time report for an agent.

FIG. 7 shows customizable report options for handle time for an omni-channel.

FIG. 8 shows a customized report for a specific agent, for a specific assigned date range, for handle time and active time for an omni-channel.

FIG. 9 illustrates a graphical UI for active time compared to handle time and productivity for an agent for an omni-channel.

FIG. 10 shows one example workflow for tracking user engagement with an online application while the user is multi-tasking among assignments.

FIG. 11 is a block diagram of an example computer system for implementing the tracking of user engagement with an online application while the user is multi-tasking among assignments in an omni-channel environment.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The tracking of user engagement with an online application while the user is multi-tasking among assignments can make organizations more efficient—tracking agents' work time from the time a task is requested, to work being pushed to the agent, to the task being fulfilled. Tasks are assigned a status. When a task is opened and accepted, the status is changed to “assigned”. When the work task is finished and the agent closes the tab, the status is changed to “closed”. Handle time refers to how long the agent had the work—a total elapsed time.

In an omni-channel environment in which as many as a hundred requests per second can be routed, service agents often respond to multiple requests, made during the same time period, for tasks that need to be completed. Separate browser panels in task-oriented tabs, subtabs or windows display each of the multiple work items in the agent console. A chat agent can often handle three different customers, by continuously bouncing among three different chat panels. When a user of the customer service system works simultaneously on multiple work items, multiplexing among assignments, it becomes important to be able to track the amount of time the agent actively spends on each of multiple requests displayed in their task-oriented tabs, subtabs or windows.

When an agent multi-tasks, the disclosed technology includes systems and methods to track how much time the agent is spending with a particular task tab open and in focus—so that administrators can track the time spent by an agent on a specific task. The focus indicates the component of the graphical user interface that is selected to receive input. Text entered at the keyboard or pasted from a clipboard is sent to the component which has the focus.

In one use case, an agent can multiplex the processing of multiple insurance claim requests, using a separate window in a console application for each insurance claim. In another example use case, a worker who handles mortgages can track time spent on each client's work. In yet another example, sales agents can track leads coming in that potentially lead to opportunities to close deals.

The disclosed technology tracks how much time an agent actively spends on each individual work item by tracking how long the tab is open and in-focus in the service console, and saves the active time, in seconds, on the agent work record in the customer's org. Agents log in to signal that they are ready to accept work. After login, work may be routed to the worker from a system queue, based on the agent's capacity and capabilities. After the agent accepts the work, either explicitly or implicitly in some system configurations, the disclosed technology begins to track the time the agent stays on the open tab. Each time the agent switches to a different tab, or back and forth, the time count stops for the previous tab and starts counting for the current tab. When the agent finally closes the work tab, the total active time spent on the related tab is saved along with the agent's work record. If an agent logs out, the active time is saved for all of their open work tabs. A subtab user interface element that is part of a tab section can also be used for tracking active time spent in some implementations.

This saved data gives useful insight to customers to know where labor time is being spent. Data also gets saved in browser local storage when the agent leaves the console—for example, when they browse to a different page or refresh the page—so that tracking of the agent's time on the task can continue, in situations in which the agent returns to the page on their console before their session times out.

The disclosed technology also includes preserving results of the tracking in a local persistent memory between updates from the user console to the online application, and the disclosed technology handles the graceful browser close scenario by sending active time data to the server before the browser closes. Recovering from a graceful browser session termination without logout includes detecting the session termination event, forwarding tracking results to a buffer as an update from the user console to the online application, and marking local persistent memory to indicate that tracking results have been forwarded to the online application

Recovery from an ungraceful browser session termination includes detecting restart of the user console, retrieving tracking results in the local persistent memory, and adding the retrieved tracking results to a buffer for transmission of an update from the user console to the online application.

In one implementation, a method of tracking user engagement with an online application while the user is multi-tasking among assignments includes causing display of a user console within a browser that interacts with an online application and supports agent interaction with multiple concurrent active assignments in separate panels within the user console; tracking interaction of the agent with respective assignments among the multiple concurrent active assignments within the user console by tracking which of the panels, if any, is currently active; and consolidating periods of agent interaction with the respective assignments, between assigning to and closing out the respective assignments.

An environment for tracking user engagement with an online application while the user is multi-tasking among assignments is described next.

### Environment

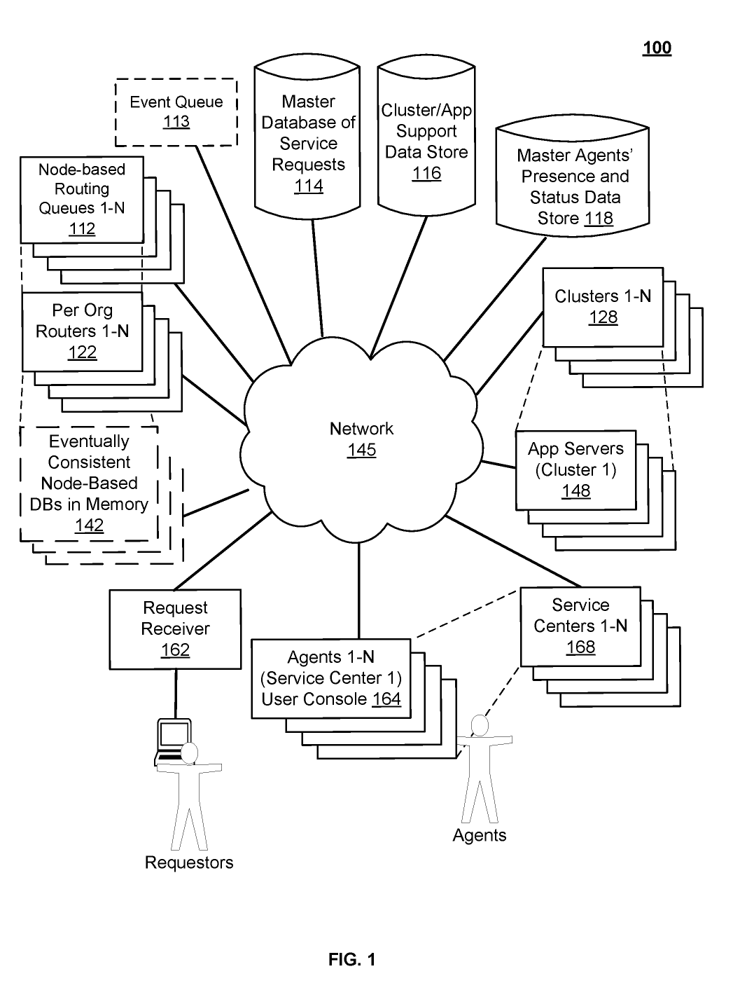

FIG. 1 illustrates an example environment 100 for tracking user engagement with an online application while the user is multi-tasking among assignments. Environment 100 includes a request receiver 162 for handling service requests from a plurality of organizations, via multiple sources: for example—email, web, SMS, chat, or live agent video support on a desktop or mobile device, or by telephone. Each organization has an agent pool disjoint from the agent pools of other organizations. Agents 1-N at user consoles 164, at service center one, complete work requests received at service centers 1-N 168. Clusters of app servers 148 serve org clusters 1-N 128, storing event information and other log data in cluster/app support data store 116. In some implementations, organizations operate on a single pod. Clusters of servers that handle traffic exist as a logical unit sometimes referred to as a “superpod” which is a group of pods.

An app server among the cluster of app servers 148 is elected to perform routing for a given org. That app server will make the routing decisions for the org. A system could have a single app server for a hundred different orgs. That is, a given app server can serve many orgs. Each org has one or more work queues for their organization's agent pool. Cluster/app support data store 116 gets updated when agents complete tasks, and signal completion by closing work, for their organizations—storing active time for agents for each task, among other data.

Environment 100, for tracking user engagement with an online application while the user is multi-tasking among assignments, makes use of multithreading to manage requests from more than one user at a time, and to manage multiple requests by the same user—tracking the presence and status of agents for multiple orgs. Current presence and status for each agent is stored in master agents' presence and status data store 118, and presence and status update events are published to event queue 113.

Environment 100 in FIG. 1 also includes eventually consistent, in-memory node-based databases 142, which get updated based on the results of receiving agent presence and status events from event queue 113. For eventually consistent databases, changes to a replicated piece of data eventually reach the affected replicas. The master presence and status data store 118 can store agent presence, agent work and status data across agent pools serving multiple nodes; and the eventually consistent in memory node-based databases 142—are subsets of the master presence and status database that is eventually consistent with the master presence and status data store 118, as a result of processing events from the event queue.

Per org routers 1-N 122 publish incoming service request events from the event queue 113 to at least one of the node-based routing queues 1-N 112. Additionally, routing broker environment 100 includes a master database of service requests 114 that provides a permanent record of events, enabling long-term event tracking and agent performance analysis.

In the case of lack of consistency between a particular routing decision and the master presence and status data store 118, a routing decision rollback event is published to the event queue 113, and the particular routing decision is not applied to the master presence and status data store 118. The node-based database—the in-memory presence and status database 118—gets updated to roll back the routing decision. That is, if unsuccessful, the state changes are rolled back and the work is made available for another routing attempt. For example, if an agent has gone offline during the routing of the request, then the system learns that the agent is not available when attempting to commit the route to the database, so the route will be rolled back as though it never happened and a new routing request will be generated. Declined and agent unavailable items go back to the queue. A new routing push attempt creates a new agent work record.

In other implementations, environment 100 may not have the same elements as those listed above and/or may have other/different elements instead of, or in addition to, those listed above.

The disclosed technology for tracking user engagement with an online application while the user is multi-tasking among assignments, described in detail below, tracks, stores and makes available user presence and agent work results, on a task by task basis, in a multi-tenant environment that handles a high volume of incoming work.

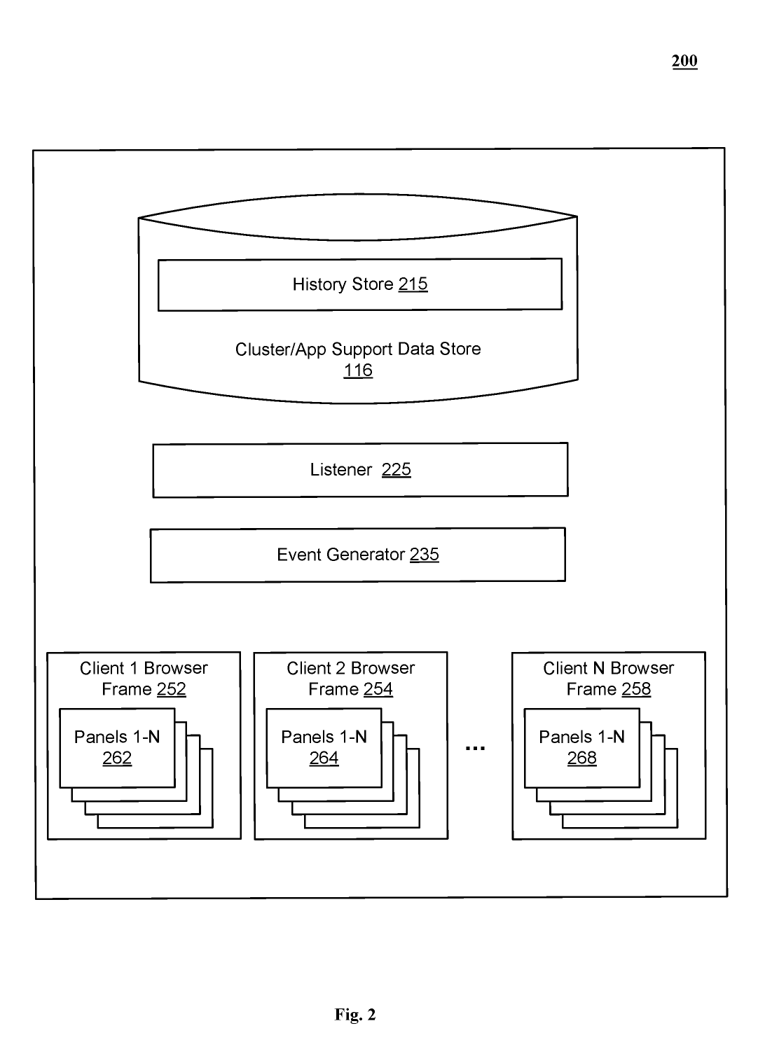

FIG. 2 shows a block diagram of components for tracking user engagement. Cluster/app support data store 116 includes history store 215, for preserving results of the tracking in a local persistent memory between updates from the user console to the online application. Tracking results include data described via the following fields: ‘service presence status’ set by the user in the service console; ‘status start date’—a date and time the presence status was set or started; ‘status end date’—a date and time when the presence status ended, either because the user changed status or logged out; ‘is current state’ that indicates whether the presence status is currently in use by the user; ‘is away’ indicates whether the status is an “online” or “busy” presence status; ‘configured capacity’—the user's configured capacity as set in their presence configuration; ‘at capacity duration’—the amount of time in seconds during this presence status that the user had workload of 100% of their capacity; ‘average capacity’ stores the amount of unused capacity in seconds during the presence session; ‘idle duration’ stores the amount of time in seconds during this presence status that the user had no omni-channel work; and user that identifies the omni-channel presence user. Additional data in the history store includes agents' work data records that contain data about when the record was requested, assigned, accepted and closed by the agent, described in detail infra.

Continuing the description of FIG. 2, event generator 235 processes events that occur as a result of agent activity in panels on their browser windows. Event generator 225 handles ‘onfocus’ events that occur when an agent clicks on a tab in the user interface. Client 1 browser frame 252 receives event notifications from panel 1-N 262. Client 2 browser frame 254 receives events from panel 1-N 264. Client N browser frame 258 receives events from panel 1-N 268. Listener 225 listens for events from event generator 235—events processed when agents take actions from clients' browser frames 252, 254, 258. In one implementation, the event listener for agent presence for logged in, status changed, login failed, logout, and work accepted events is set up as listed next.

```
//Core Event Listener for Presence and AgentWork
  var events = servicepresence.Events;
  servicepresence.addEventListener(events.LOGIN_SUCCESS,
Sfdc.Function.bind(this.handlePresenceLogin, this));
  servicepresence.addEventListener(events.STATUS_CHANGED,
Sfdc.Function.bind(this.handlePresenceChanged, this));
  servicepresence.addEventListener(events.LOGIN_FAILED,
Sfdc.Function.bind(this.handlePresenceLogout, this));
  servicepresence.addEventListener(events.LOGOUT,
Sfdc.Function.bind(this.handlePresenceLogout, this));
  servicepresence.addEventListener(events.WORK_ACCEPTED,
Sfdc.Function.bind(this.handleAcceptedWork, this));
```

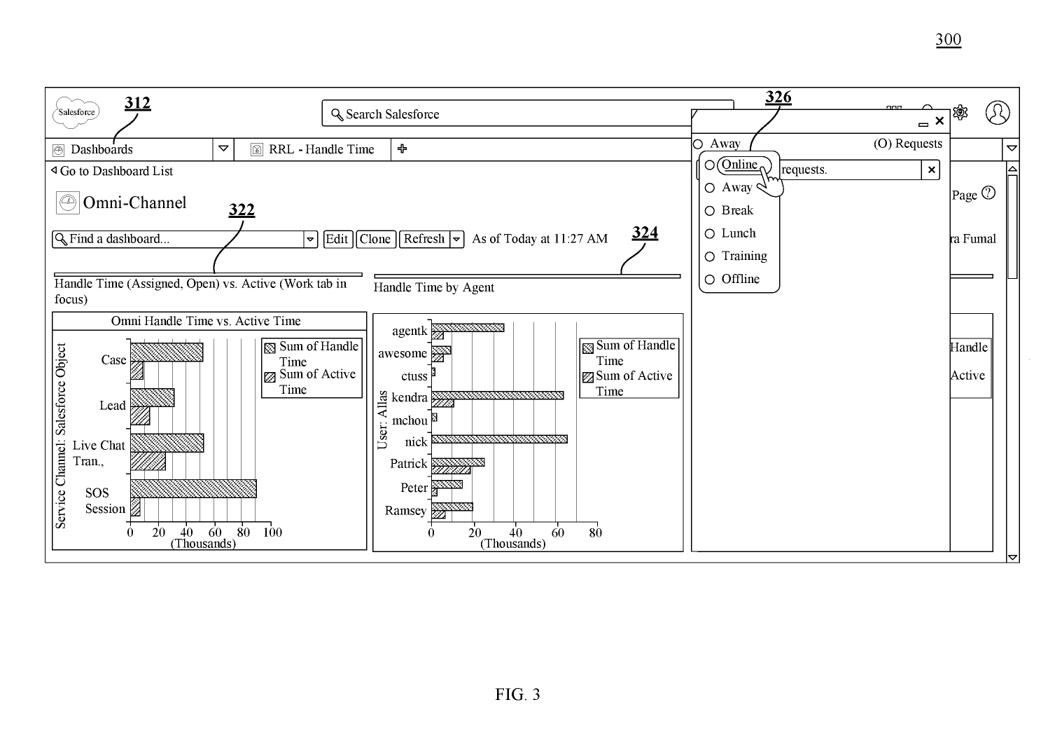

FIG. 3 shows an example user interface 300 for tracking user engagement with an online application while the user is multi-tasking among assignments in a multi-tenant, multi-threaded omni-channel routing broker system. The UI includes a service control panel with dashboard 312 via which agents can select options for accepting work, can multiplex between multiple tasks, and can close work when the work is completed. Each time a work item is routed to an agent, a record in the agent's work record gets created, which is described in detail later.

An agent can multi-task among assignments, which are each displayed in a panel in a browser window of the dashboard in a separate tab or window. Active time—how much time an agent actively spends on each individual work item—can be tracked by tracking the amount of time that the tab is open and in focus, and saving the active time in seconds in the agent work record in the customer's org. This active time data gives useful insight to an organization's customers for understanding where labor's time is being spent. On-focus events for console tabs are tracked to determine the active time.

In one implementation, an onFocusedPrimaryTab function registers an event handling function to call when the focus of the browser changes to a different primary tab. The event handler method gets called when the focus of the browser changes to a different primary tab. This method is asynchronous, so it returns its response in an object in a callback method. The response object contains a title field that contains a string that is the id of the primary tab on which the browser is focused and an objectId field that contains a string that represents the object ID of the primary tab on which the browser is focused or null if no object.

sforce.console.onFocusedPrimaryTab(eventHandler:Function)

The example ActiveTimeTracker is integrated with service desk events like onFocusedPrimaryTab, onFocusedSubtab, and onFocusedNavigatorPanel as listed next, registering onFocused events to tab navigator, to track active time.

```
SfdcApp.Presence.Console.Core.INSTANCE = null;
SfdcApp.Presence.Console.Core.init = function(endpoint, contentEndpoint,
      organizationId, sessionId, currentTabSetId, channelToWidget) {
  if (SfdcApp.Presence.Console.Core.INSTANCE === null &&
      typeof(window.servicepresence) !== “undefined”) {
      SfdcApp.Presence.Console.Core.INSTANCE = new
      SfdcApp.Presence.Console.Core(endpoint, contentEndpoint, organizationId,
      sessionId, currentTabSetId, channelToWidget);
    if (servicepresence) {
        var activeTimeTracker = servicepresence.getActiveTimeTracker( );
        if (activeTimeTracker) {
          activeTimeTracker.init(Sfdc);
          Sfdc.support.servicedesk.ApiHandler.onFocusedPrimaryTab(null,
            {frameId: SCC_WIDGET_NAME},
            activeTimeTracker.onFocusedPrimaryTab);
          Sfdc.support.servicedesk.ApiHandler.onFocusedSubtab(null, {frameId:
            SCC_WIDGET_NAME}, activeTimeTracker.onFocusedSubtab);
          Sfdc.support.servicedesk.ApiHandler.onFocusedNavigatorPanel(null,
            {frameId: SCC_WIDGET_NAME},
            activeTimeTracker.onFocusedNavigatorPanel);
        }
    }
  }
};
```

Dashboard 312 in FIG. 3 shows a panel that an agent accepting work might view and includes a graph of handle time vs. active 322 that shows the contrast between the amount of time a work task is assigned and open, compared to the amount of active time the work task tab is in focus. A second graph of handle time by agent 324 shows—for multiple agents each identified by their alias, the sum of handle time and sum of active times. FIG. 3 also shows an agent options popup, which shows agent options 326: online, away, break, lunch, training and offline. Agents can set their availability to receive work by selecting “online”. In another use case, for another organization, the choices for a worker can be different than those shown in FIG. 3. Environment 100 routes work to the agent, from the queue, based on the agent's capacity and availability.

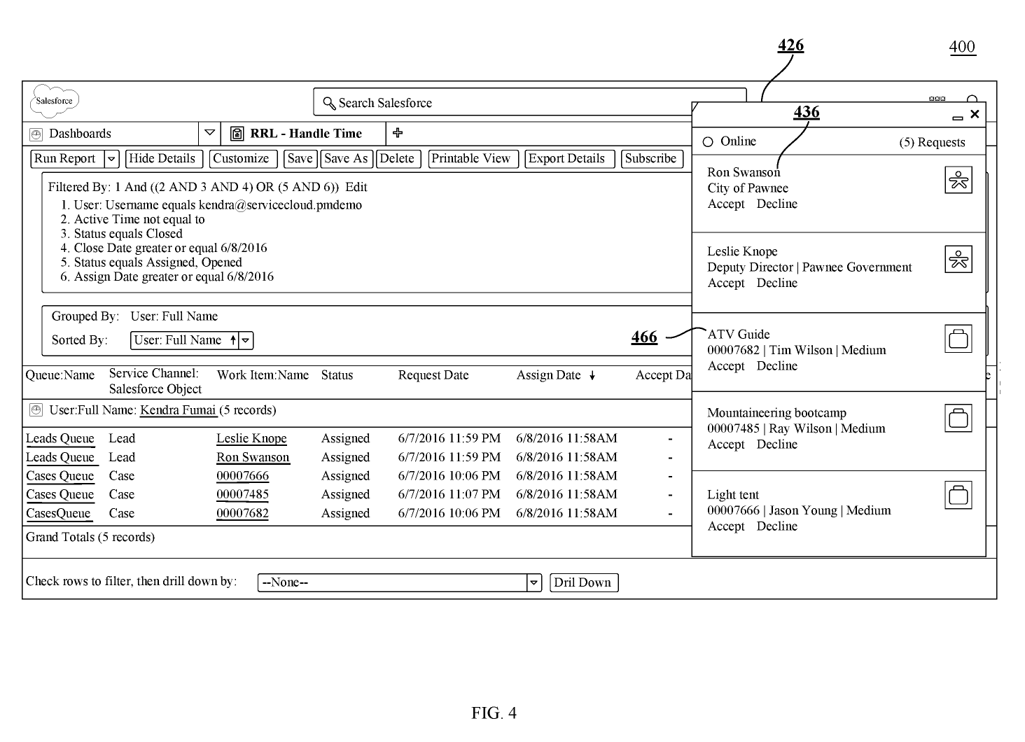

FIG. 4 shows an example view of incoming leads and cases 426 that the agent receives after they signal that they are online and available. In this use case example, the agent can work on multiple tasks, so can select both Ron Swanson 436 and ATV Guide 466.

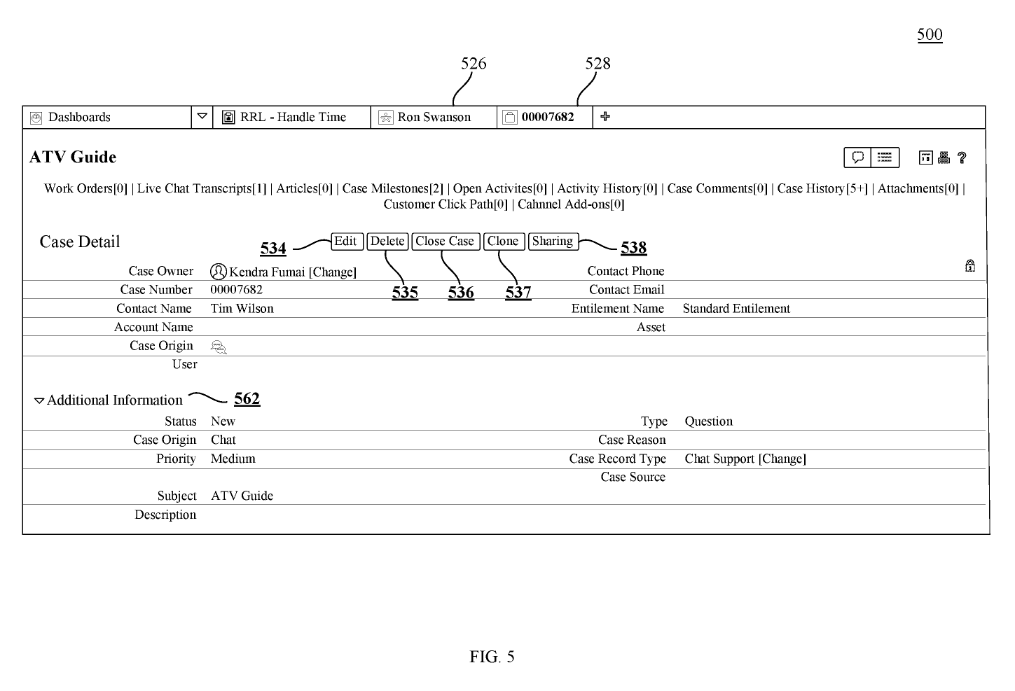

FIG. 5 shows agent dashboard 500 with an active tab 00007682 528 illustrating the case detail for the work case 00007682 for ATV Guide 466. The agent can take various actions relative to the work: edit 534, delete 535, close case 536, clone 537 and sharing 538. Additional information 562 shows that the origin of the work case is a chat and the case has medium priority. The dashboard also shows another selected work case—a Ron Swanson inactive tab 526. The agent, case owner Kendra, can select either of the two tabs 526, 528 to continue actively working on the two cases and can jump back and forth between the two case tabs, multiplexing to complete the work, and then can close the tab when the case is complete.

From the moment an agent accepts a work, either automatically or explicitly, environment 100 starts tracking the time the agent stays on the tab. When the agent switches to a different tab, or back and forth between tabs, the environment stops counting time for their previous tab and starts counting for the current tab. When the agent finally closes the work tab, environment 100 saves the total active time spent on the related tab and saves it along with agent's record, and saving all active time for an agent when they log out, for all their open work tabs.

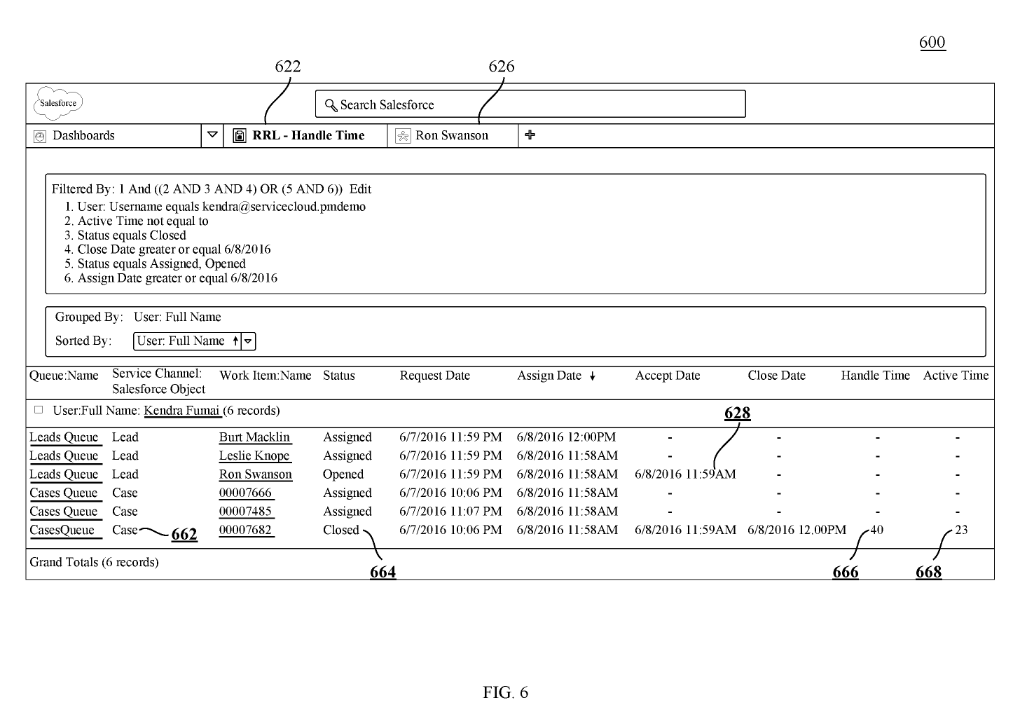

FIG. 6 shows agent dashboard 600 after case agent Kendra closes tab 00007682 528. Note that handle time and active time are not yet available for Ron Swanson work item because the Ron Swanson tab 626 is still available (not closed), though inactive in FIG. 6. Handle time report tab 622 displays a report of the cases queue 662 for work item 00007682 with status closed, with values for handle time 666 of forty seconds and active time 668 of twenty-three seconds. Environment 100 saves the data from the handle time object and the active time object, and that data can be made available as customer port types. This data can be brought into other systems for display and analysis, via simple object access protocol (SOAP) APIs, in one implementation. We show and describe example display options in more detail later.

Data also gets saved in browser local storage when the agent leaves the console—for example, when they browse to a different page or refresh the page—so that tracking of the agent's time on the task can continue, in situations in which the agent returns to the page on their console before their session times out. The disclosed technology also includes preserving results of the tracking in a local persistent memory between updates from the user console to the online application, and handles the graceful browser close scenario by sending active time data to the server before the browser closes.

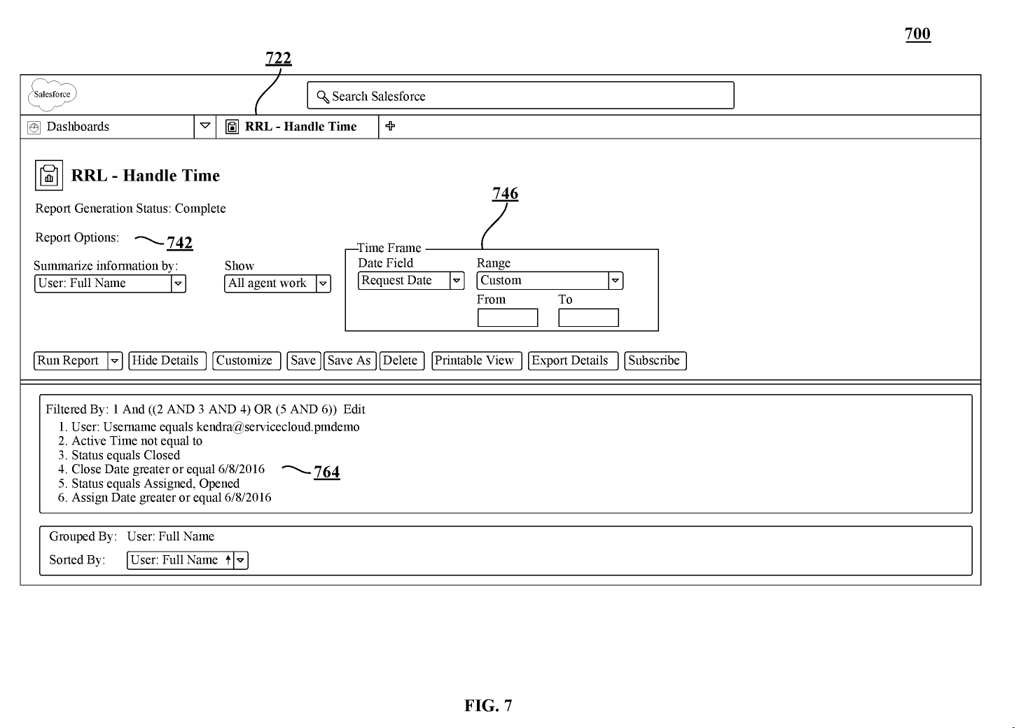

FIG. 7 shows an active panel for report handling dashboard 700 with handle time report tab 722 with report options 742 for selecting what data is to be reported in the panel, and in a selected time frame 746. The report data can be customized, saved, deleted, printed, exported or a subscription can be set up in this example report interface.

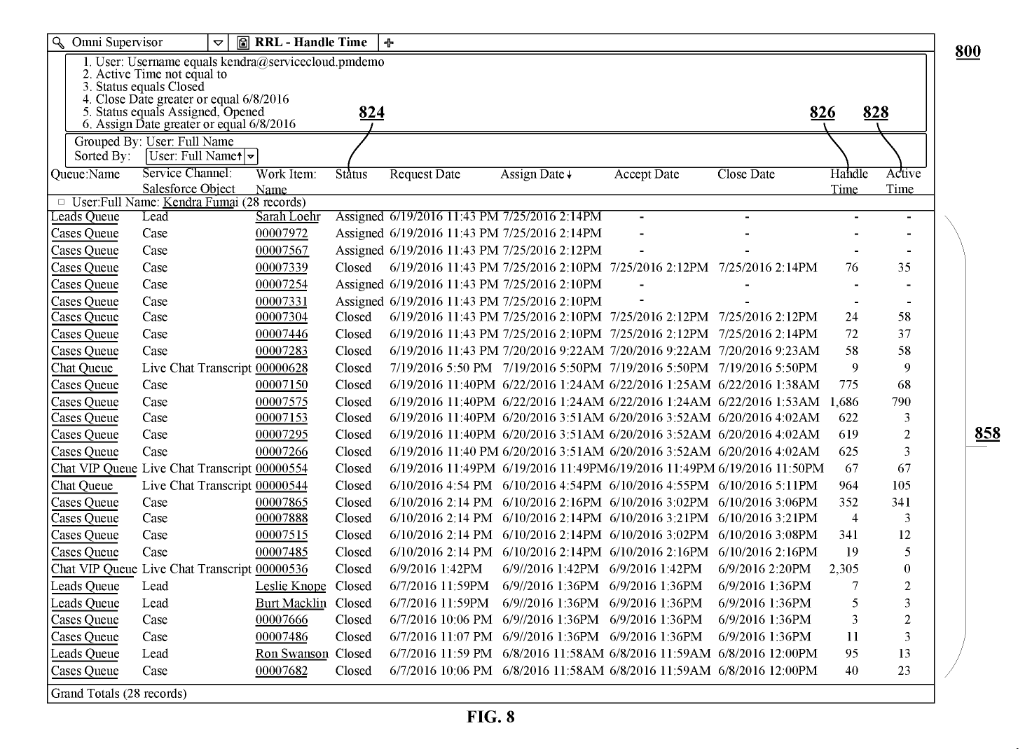

FIG. 8 shows report results 800 for case agent Kendra for leads that closed on or after Jun. 8, 2016, and for leads assigned to Kendra. Note that handle time and closed time values are reported for the work items whose status 824 is ‘closed’. The disclosed technology tracks ‘handle time’ 826 and ‘active time’ 828 and the values are stored in the agent work record, usable to track productivity and other aspects of work assignments for agents. Graphical representations of the data 858 enable ease of analysis of performance. Graphical representations are described infra.

The agent work data record contains data about when the record was requested, assigned, accepted and closed by the agent. This information helps companies understand wait time—the accepted time minus the request time; average handle time (AHT)—the closed time minus the accepted time; and agent behavior for accepting and declining work. The disclosed technology includes tracking agents' presence statuses and agent work statuses, which are listed next. In another implementation of the disclosed technology the field names and data types can be different than the field names and data types listed below.

| Field | Data Type | Description |
|---|---|---|
| Queue | Lookup (Queue) | Queue from which work was routed |
| Service Channel | Lookup (Service Channel) | Service channel associated with work |
| Request Date | Date/Time | Time the work item was requested (i.e. |
| | | ownership set to an omni queue) |
| Assign Date | Date/Time | Time the work items was assigned to the |
| | | agent (i.e. delivered to the agent's omni |
| | | widget) |
| Accept Date | Date/Time | Time the work item was accepted by the |
| | | omni user (when accepted, the agent work |
| | | record's status is “Opened” |
| Decline Date | Date/Time | Time the work item was declined by the |
| | | omni user (this sets the agent work record's |
| | | status to “Declined” and the item is re- |
| | | routed) |
| Close Date | Date/Time | Time the work item's tab was closed in the |
| | | Console by the omni user (this sets the |
| | | agent work record's status to “Closed”) |
| Status | Picklist | Status of the work record, includes |
| | | Assigned, Opened, Closed, and Declined |
| Handle Time | Number(9, 0) | Duration in seconds between the accept |
| | | time and the close time (i.e. how long was |
| | | the work open with the agent) |
| Active Time | Number(9, 0) | Duration in seconds of the time the work |
| | | item's tab was actively in focus in the |
| | | agent's Console. This will be less than or |
| | | equal to the Handle Time. |
| Speed To | Number(9, 0) | Duration in seconds between the request |
| Answer | | time and accept time |
| Agent Capacity | Number(8, 2) | Amount of capacity the agent had when he |
| when Declined | | declined the work request |
| Percentage of | Percent(3, 2) | Configured percentage of capacity (based |
| Capacity | | on the routing configuration from the |
| | | queue) the work item would consume from |
| | | the agent's total capacity |
| Units of | Number(8, 2) | Configured units of capacity (based on the |
| Capacity | | routing configuration from the queue) the |
| | | work item would consume from the agent's |
| | | total capacity |
| User | Lookup(User) | User to which the work was pushed |

Event handling results for a service channel are stored in a database, to fulfill a requirement of many large organizations for recording permanent and highly available event logs that enable event tracking, agent activity tracking, and performance analysis.

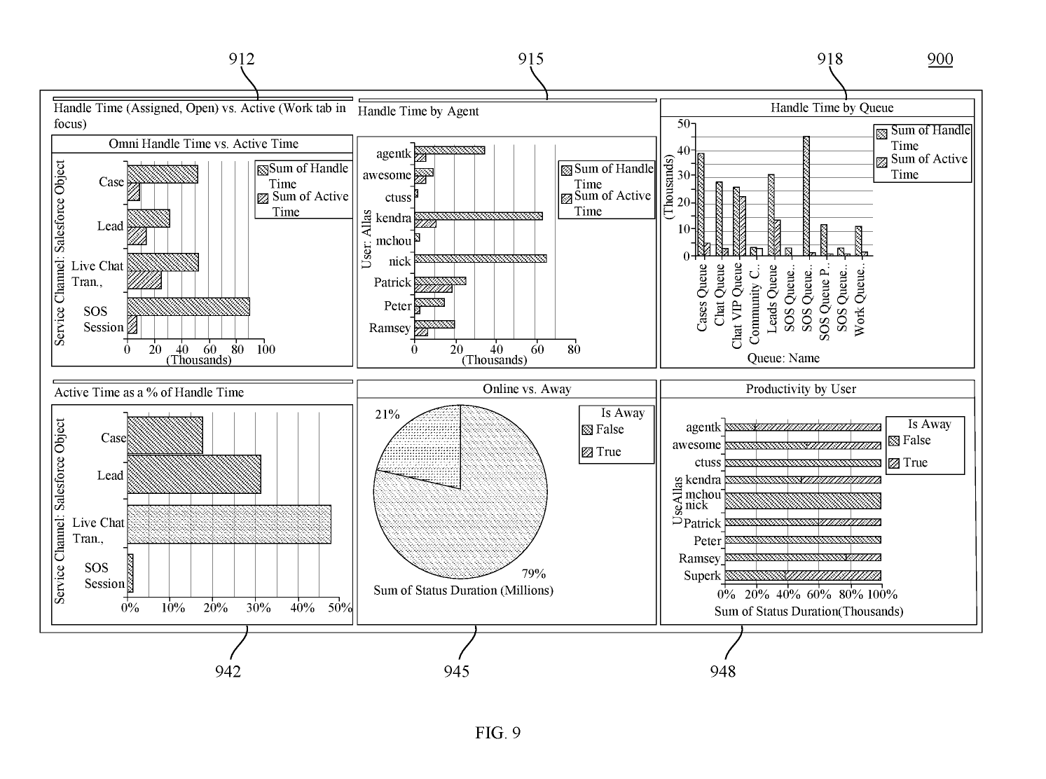

FIG. 9 shows six graphical representations of captured handle time and active time, usable to analyze activity and performance across work cases and users. By adding handle time and active time tracking to reports for agent work, analysts can surmise how quickly agents complete specific tasks. ‘Handle time vs active time’ 912 shows the time in thousands of seconds for cases, leads, live chats and SOS sessions. ‘Handle time by agent’ 915 shows a comparison of handle time and active time for multiple agents. ‘Handle time by queue’ 918 compares handle time to active time for different queues, in thousands of seconds. ‘Active time as a % of handle time’ 942 shows the percentage of time that a service channel is active for an agent for various types of work, including cases, leads, live chats and SOS sessions. A cursory analysis shows that a very small percentage of time in an SOS session is active. ‘Online versus away’ 945 is shown as a pie chart, for the sum of status duration, displaying twenty-one percent time away. ‘Productivity by user’ 948 compares time away for a list of users by alias. It is noteworthy to a supervisor managing workers that two of the agents are never away, based on the available data.

### User Engagement Tracking Workflow

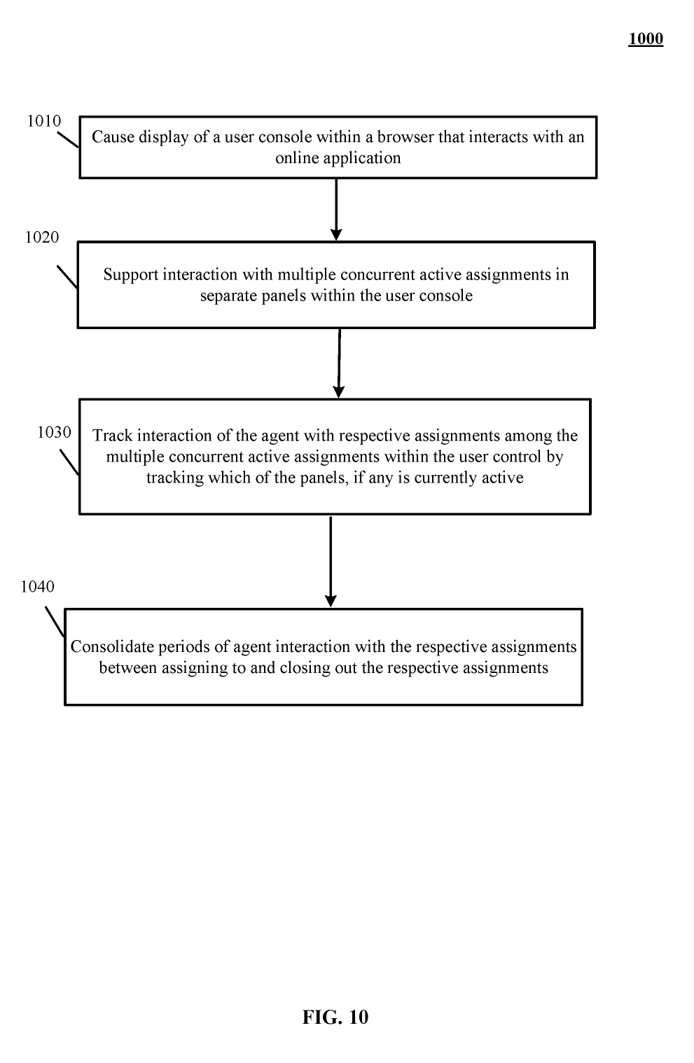

FIG. 10 shows an example workflow 1000 of tracking user engagement with an online application while the user is multi-tasking among assignments. Workflow 1000 can be implemented at least partially with a database system, e.g., by one or more processors configured to receive or retrieve information, process the information, store results, and transmit the results. Other implementations may perform the steps in different orders and/or with different, fewer or additional steps than the ones illustrated in FIG. 10. Multiple steps can be combined in some implementations.

At action 1010, causing display of a user console within a browser that interacts with an online application.

At action 1020, supporting interaction with multiple concurrent active assignments in separate panels within the user console.

At action 1030, tracking interaction of the agent with respective assignments among the multiple concurrent active assignments within the user control by tracking which of the panels, if any is currently active.

At action 1040, consolidating periods of agent interaction with the respective assignments between assigning to and closing out the respective assignments.

### Computer System

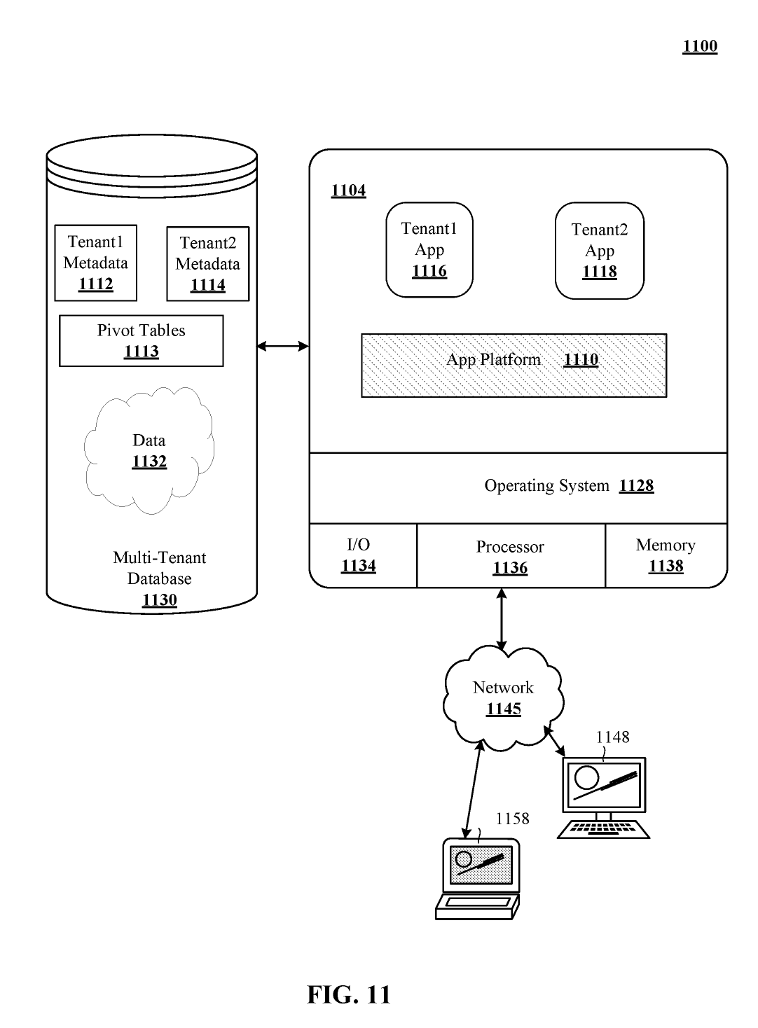

FIG. 11 presents a block diagram of an exemplary multi-tenant system 1100 suitable for tracking user engagement with an online application while the user is multi-tasking among assignments, in environment 100 of FIG. 1. In general, the illustrated multi-tenant system 1100 of FIG. 11 includes a server 1104 that dynamically creates and supports virtual applications 1116 and 1118, based upon data 1132 from a common multi-tenant database 1130 that is shared between multiple tenants, alternatively referred to herein as a “multi-tenant database”. Data and services generated by the virtual applications 1116 and 1118, including GUI clients, are provided via a network 1145 to any number of client devices 1148 or 1158, as desired.

As used herein, a “tenant” or an “organization” refers to a group of one or more users that shares access to common subset of the data within the multi-tenant database 1130. In this regard, each tenant includes one or more users associated with, assigned to, or otherwise belonging to that respective tenant. Stated another way, each respective user within the multi-tenant system 1100 is associated with, assigned to, or otherwise belongs to a particular tenant of the plurality of tenants supported by the multi-tenant system 1100. Tenants may represent users, user departments, work or legal organizations, and/or any other entities that maintain data for particular sets of users within the multi-tenant system 1100. Although multiple tenants may share access to the server 1104 and the database 1130, the particular data and services provided from the server 1104 to each tenant can be securely isolated from those provided to other tenants. The multi-tenant architecture therefore allows different sets of users to share functionality and hardware resources without necessarily sharing any of the data 1132 belonging to or otherwise associated with other tenants.

The multi-tenant database 1130 is any sort of repository or other data storage system capable of storing and managing the data 1132 associated with any number of tenants. The database 1130 may be implemented using any type of conventional database server hardware. In various implementations, the database 1130 shares processing hardware with the server 1104. In other implementations, the database 1130 is implemented using separate physical and/or virtual database server hardware that communicates with the server 1104 to perform the various functions described herein. The multi-tenant database 1130 may alternatively be referred to herein as an on-demand database, in that the multi-tenant database 1130 provides (or is available to provide) data at run-time to on-demand virtual applications 1116 or 1118 generated by the application platform 1110, with tenant1 metadata 1112 and tenant2 metadata 1114 securely isolated.

In practice, the data 1132 may be organized and formatted in any manner to support the application platform 1110. In various implementations, conventional data relationships are established using any number of pivot tables 1113 that establish indexing, uniqueness, relationships between entities, and/or other aspects of conventional database organization as desired.

The server 1104 is implemented using one or more actual and/or virtual computing systems that collectively provide the dynamic application platform 1110 for generating the virtual applications. For example, the server 1104 may be implemented using a cluster of actual and/or virtual servers operating in conjunction with each other, typically in association with conventional network communications, cluster management, load balancing and other features as appropriate. The server 1104 operates with any sort of conventional processing hardware such as a processor 1136, memory 1138, input/output features 1134 and the like. The input/output devices 1134 generally represent the interface(s) to networks (e.g., to the network 1145, or any other local area, wide area or other network), mass storage, display devices, data entry devices and/or the like. User interface input devices 1134 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include possible types of devices and ways to input information into server 1104.

User interface output devices can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from processor 1136 to the user or to another machine or computer system.

The processor 1136 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 1138 represents any non-transitory short or long term storage or other computer-readable media capable of storing programming instructions for execution on the processor 1136, including any sort of random access memory (RAM), read only memory (ROM), flash memory, magnetic or optical mass storage, and/or the like. The computer-executable programming instructions, when read and executed by the server 1104 and/or processor 1136, cause the server 1104 and/or processor 1136 to create, generate, or otherwise facilitate the application platform 1110 and/or virtual applications 1116 and 1118, and perform one or more additional tasks, operations, functions, and/or processes described herein. It should be noted that the memory 1138 represents one suitable implementation of such computer-readable media, and alternatively or additionally, the server 1104 could receive and cooperate with external computer-readable media that is realized as a portable or mobile component or application platform, e.g., a portable hard drive, a USB flash drive, an optical disc, or the like.

The application platform 1110 is any sort of software application or other data processing engine that generates the virtual applications 1116 and 1118 that provide data and/or services to the client devices 1148 and 1158. In a typical implementation, the application platform 1110 gains access to processing resources, communications interfaces and other features of the processing hardware using any sort of conventional or proprietary operating system 1128. The virtual applications 1116 and 1118 are typically generated at run-time in response to input received from the client devices 1148 and 1158.

With continued reference to FIG. 11, the data and services provided by the server 1104 can be retrieved using any sort of personal computer, mobile telephone, tablet or other network-enabled client device 1148 or 1158 on the network 1145. In an exemplary implementation, the client device 1148 or 1158 includes a display device, such as a monitor, screen, or another conventional electronic display capable of graphically presenting data and/or information retrieved from the multi-tenant database 1130.

In some implementations, network(s) 1145 can be any one or any combination of Local Area Network (LAN), Wide Area Network (WAN), WiMAX, Wi-Fi, telephone network, wireless network, point-to-point network, star network, token ring network, hub network, mesh network, peer-to-peer connections like Bluetooth, Near Field Communication (NFC), Z-Wave, ZigBee, or other appropriate configuration of data networks, including the Internet.

The foregoing description is merely illustrative in nature and is not intended to limit the implementations of the subject matter or the application and uses of such implementations. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary implementations described herein are not intended to limit the scope or applicability of the subject matter in any way.

The technology disclosed can be implemented in the context of any computer-implemented system including a database system, a multi-tenant environment, or a relational database implementation like an ORACLE™ compatible database implementation, an IBM DB2 Enterprise Server compatible relational database implementation, a MySQL or PostgreSQL compatible relational database implementation or a Microsoft SQL Server compatible relational database implementation or a NoSQL non-relational database implementation such as a Vampire™ compatible non-relational database implementation, an Apache Cassandra™ compatible non-relational database implementation, a BigTable compatible non-relational database implementation or an HBase or DynamoDB compatible non-relational database implementation.

Moreover, the technology disclosed can be implemented using two or more separate and distinct computer-implemented systems that cooperate and communicate with one another. The technology disclosed can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

### Particular Implementations

In one implementation, a method disclosed for tracking user engagement with an online application while the user is multi-tasking among assignments, includes causing display of a user console within a browser that interacts with an online application and supports agent interaction with multiple concurrent active assignments in separate panels within the user console; tracking interaction of the agent with respective assignments among the multiple concurrent active assignments within the user console by tracking which of the panels, if any, is currently active; and consolidating periods of agent interaction with the respective assignments, between assigning to and closing out the respective assignments.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features that implement staging and deployment launch.

For some implementations the disclosed method includes causing display of multiple user panels on user consoles for multiple agents; tracking multiple agents' interaction with a respective assignment based on which of the multiple agents' panels are active; and consolidating the periods of agent interaction for a particular assignment, across agents and user consoles. The method can further include tracking the agent interaction with the respective assignments based on at least one of an active tab, active subtab or window. Also, the method can include tracking context of the agent interaction with data objects that implement the respective assignments.

The disclosed method further includes preserving results of the tracking in a local persistent memory between updates from the user console to the online application; and recovering from an ungraceful browser session termination by detecting restart of the user console, retrieving tracking results in the local persistent memory, and adding the retrieved tracking results to a buffer for transmission of an update from the user console to the online application. The disclosed method also includes recovering from a graceful browser session termination without logout by detecting a session termination event, forwarding tracking results to a buffer as an update from the user console to the online application, and marking local persistent memory to indicate that tracking results have been forwarded to the online application.

In some implementations, the method also includes tracking user interaction with computer resources outside a user console and outside the browser by querying an operating system under which the user console runs to obtain an identity of an application outside the browser, with which the user is interacting.

Also, the disclosed method includes causing display of a graphical representation, for one or more users, of a timeline of active tasks with graphical representations of overlapping active periods and durations of focus during the overlapping active periods.
For some implementations, the disclosed method further includes the online application storing reported tracking results in data objects within a system that provides tools for analysis of user engagement. The method can further include providing the data objects and data consolidating periods of agent interaction for a particular assignment, across agents and user consoles, for further processing by other applications.

Other implementations may include a computer implemented system of tracking user engagement with an online application while the user is multi-tasking among assignments in a large, distributed service center, including a processor, memory coupled to the processor, and computer instructions loaded into the memory that, when executed, cause the processor to implement a process that includes causing display of a user console within a browser that interacts with an online application and supports agent interaction with multiple concurrent active assignments in separate panels within the user console; tracking interaction of the agent with respective assignments among the multiple concurrent active assignments within the user console by tracking which of the panels, if any, is currently active; and consolidating periods of agent interaction with the respective assignments, between assigning to and closing out the respective assignments. Other implementations may include a computer implemented system to perform any of the methods described above, the system including a processor, memory coupled to the processor, and computer instructions loaded into the memory.

Yet another implementation may include a tangible computer readable storage medium including computer program instructions that cause a computer to implement any of the methods described above. The tangible computer readable storage medium does not include transitory signals.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

What is claimed is:

1. A method of tracking user engagement with an online application while the user is multi-tasking among assignments, including:
causing display of a user console within a browser that interacts with an online application and supports agent interaction with multiple concurrent active assignments in separate panels within the user console;
tracking interaction of the agent with respective assignments among the multiple concurrent active assignments within the user console by tracking which of the panels, if any, is currently active; and
consolidating periods of agent interaction with the respective assignments, between assigning to and closing out the respective assignments.

2. The method of claim 1, further including:
causing display of multiple user panels on user consoles for multiple agents;
tracking multiple agents' interaction with a respective assignment based on which of the multiple agents' panels are active; and
consolidating the periods of agent interaction for a particular assignment, across agents and user consoles.

3. The method of claim 1, further including tracking the agent interaction with the respective assignments based on at least one of an active tab, active subtab or window.

4. The method of claim 1, further including tracking context of the agent interaction with data objects that implement the respective assignments.

5. The method of claim 1, further including preserving results of the tracking in a local persistent memory between updates from the user console to the online application.

6. The method of claim 5, further including recovering from an ungraceful browser session termination by detecting restart of the user console, retrieving tracking results in the local persistent memory, and adding the retrieved tracking results to a buffer for transmission of an update from the user console to the online application.

7. The method of claim 5, further including recovering from a graceful browser session termination without logout by detecting a session termination event, forwarding tracking results to a buffer as an update from the user console to the online application, and marking local persistent memory to indicate that tracking results have been forwarded to the online application.

8. The method of claim 1, further including tracking user interaction with computer resources outside a user console and outside the browser by querying an operating system under which the user console runs to obtain an identity of an application outside the browser, with which the user is interacting.

9. The method of claim 1, further including causing display of a graphical representation, for one or more users, of a timeline of active tasks with graphical representations of overlapping active periods and durations of focus during the overlapping active periods.

10. The method of claim 1, further including the online application storing reported tracking results in data objects within a system that provides tools for analysis of user engagement.

11. The method of claim 10, further including providing the data objects and data consolidating periods of agent interaction for a particular assignment, across agents and user consoles, for further processing by other applications.

12. A system of tracking user engagement with an online application while the user is multi-tasking among assignments in a large, distributed service center, the system including:
a processor, memory coupled to the processor, and computer instructions loaded into the memory that, when executed, cause the processor to implement a process that includes:
causing display of a user console within a browser that interacts with an online application and supports agent interaction with multiple concurrent active assignments in separate panels within the user console;
tracking interaction of the agent with respective assignments among the multiple concurrent active assignments within the user console by tracking which of the panels, if any, is currently active; and
consolidating periods of agent interaction with the respective assignments, between assigning to and closing out the respective assignments.

13. The system of claim 12, further including:
causing display of multiple user consoles for multiple agents;
tracking multiple agents' interaction with a respective assignment based on which of the multiple agents' panels are active; and
consolidating the periods of agent interaction for a particular assignment, across agents and user consoles.

14. The system of claim 12, further including tracking the agent interaction with the respective assignments based on at least one of an active tab or window.

15. The system of claim 12, further including tracking context of the agent interaction with data objects that implement the respective assignments.

16. The system of claim 12, further including preserving results of the tracking in a local persistent memory between updates from the user console to the online application.

17. The system of claim 16, further including recovering from an ungraceful browser session termination by detecting restart of the user console, retrieving tracking results in the local persistent memory, and adding the retrieved tracking results to a buffer for transmission of an update from the user console to the online application.

18. The system of claim 16, further including recovering from a graceful browser session termination without logout by detecting a session termination event, forwarding tracking results to a buffer as an update from the user console to the online application, and marking local persistent memory to indicate that tracking results have been forwarded to the online application.

19. The system of claim 12, further including tracking user interaction with computer resources outside a user console and outside the browser by querying an operating system under which the user console runs to obtain an identity of an application outside the browser, with which the user is interacting.

20. A tangible computer readable storage medium loaded with computer instructions that, when executed, cause a computer system to perform actions that track user engagement with an online application while the user is multi-tasking among assignments, the actions including:
causing display of a user console within a browser that interacts with an online application and supports agent interaction with multiple concurrent active assignments in separate panels within the user console;
tracking interaction of the agent with respective assignments among the multiple concurrent active assignments within the user console by tracking which of the panels, if any, is currently active; and
consolidating periods of agent interaction with the respective assignments, between assigning to and closing out the respective assignments.

21. A tangible computer readable storage medium of claim 20, further including:
causing display of multiple user consoles for multiple agents;
tracking multiple agents' interaction with a respective assignment based on which of the multiple agents' panels are active; and
consolidating the periods of agent interaction for a particular assignment, across agents and user consoles.

22. The tangible computer readable storage medium of claim 20, further including tracking the agent interaction with the respective assignments based on at least one of an active tab or window.

23. The tangible computer readable storage medium of claim 20, further including causing display of a graphical representation, for one or more users, of a timeline of active tasks with graphical representations of overlapping active periods and durations of focus during the overlapping active periods.

24. The tangible computer readable storage medium of claim 20, further including tracking context of the agent interaction with data objects that implement the respective assignments.

25. The tangible computer readable storage medium of claim 20, further including the online application storing reported tracking results in data objects within a system that provides tools for analysis of user engagement.
